(19) United States
(12) Patent Application Publication
(10) Pub. No.: US 2017/0180602 A1
(43) Pub. Date: Jun. 22, 2017

(54) IMAGE PROCESSING APPARATUS WITH MEMORY STORING PRE-PROCESSED IMAGE DATA

(71) Applicants: KABUSHIKI KAISHA TOSHIBA, Tokyo (JP); TOSHIBA TEC KABUSHIKI KAISHA, Tokyo (JP)

(72) Inventor: Ryo Yoshida, Numazu (JP)

(21) Appl. No.: 14/977,958

(22) Filed: Dec. 22, 2015

(51) Int. Cl. H04N 1/393; H04N 1/21

(52) U.S. Cl. CPC H04N 1/3935; H04N 1/2104; H04N 2201/0094

(57) ABSTRACT

An image processing apparatus comprises a scanner section, a pre-processing section, a memory and a post-processing section. The scanner section reads a document to output first image data. The pre-processing section carries out a pre-processing serving as an image processing that is not changed according to setting of a user for the first image data output by the scanner section to output second image data. The memory stores the second image data output by the pre-processing section. The post-processing section carries out a post-processing serving as an image processing that is changed according to setting of the user for the second image data output by the pre-processing section to output third image data, and if the setting is changed, carries out the post-processing corresponding to the changed setting for the second image data read from the memory to output the third image data.

### FIELD

Embodiments described herein relate generally to an image processing apparatus.

### BACKGROUND

Conventionally, a scanner device is used that reads a document, files digitized document data and stores the document data. The scanner device performs various image processing corresponding to the setting of a user on the document data. There is a problem that a processing load concentrates in a CPU (Central Processing Unit) in the scanner device if the image processing is carried out by a software processing. In order to solve the problem, it is considered to carry out a part of the image processing corresponding to the setting of the user through hardware. The scanner device includes a function of being capable of confirming an image processed according to the setting of the user through a preview display before the image is output.

However, in the structure of carrying out the image processing through the hardware, in a case in which a result obtained by viewing the preview display is different from assumption, it is necessary to read the document again after the setting is changed. Thus, there is a problem that the job of reading such a document again becomes the burden of the user if a large number of documents are read.

### BRIEF DESCRIPTION OF THE DRAWINGS

FIG. 1 is an external diagram exemplifying the whole structure of an image processing apparatus 100 according to an embodiment;

FIG. 2 is a schematic diagram exemplifying the structure of an image reading section 200;

FIG. 3 is a schematic diagram exemplifying the structure of a system control section 30; and

FIG. 4 is a schematic diagram exemplifying a scanning operation carried by an image processing apparatus 100.

### DETAILED DESCRIPTION

An image processing apparatus of an embodiment comprises a scanner section, a pre-processing section, a memory and a post-processing section. The scanner section reads a document to output first image data. The pre-processing section carries out a pre-processing serving as an image processing that is not changed according to setting of a user for the first image data output by the scanner section to output second image data. The memory stores the second image data output by the pre-processing section. The post-processing section carries out a post-processing serving as an image processing that is changed according to setting of the user for the second image data output by the pre-processing section to output third image data, and if the setting is changed, carries out the post-processing corresponding to the changed setting for the second image data read from the memory to output the third image data.

Hereinafter, the image processing apparatus of the embodiment is described with reference to the accompanying drawings.

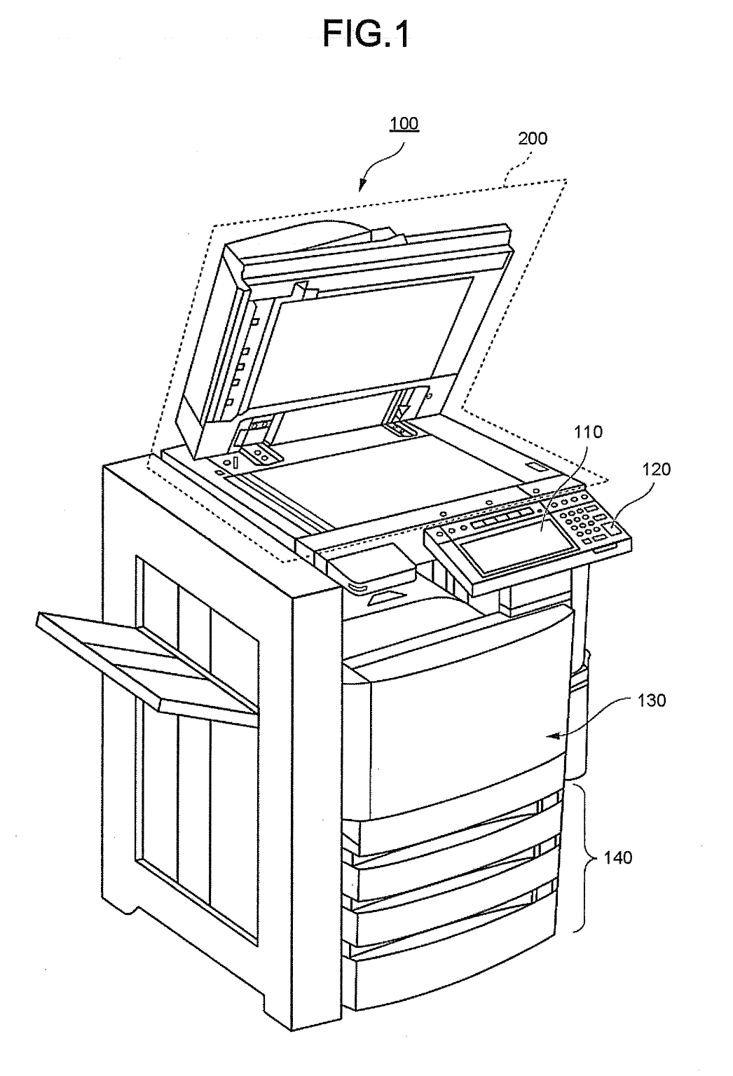

FIG. 1 is an external diagram exemplifying the whole structure of an image processing apparatus 100 according to the embodiment. The image processing apparatus 100 is, for example, an image forming apparatus such as a digital MFP (multi-functional peripheral). The image processing apparatus 100 is provided with an operation display section 110, a controller panel 120, a printer section 130, a sheet accommodation section 140 and an image reading section 200. The printer section 130 of the image processing apparatus 100 may be a device for fixing a toner image or an inkjet type device.

The image processing apparatus 100 reads an image displayed on a sheet and generates digital data to generate an image file. The sheet is, for example, a document and a paper on which characters or images are recorded. The sheet may be an optional medium as long as it can be read by the image processing apparatus 100.

The operation display section 110 is an image display device such as a liquid crystal display, an organic EL (electro luminescence) display. The operation display section 110 displays various kinds of information relating to the image processing apparatus 100. The operation display section 110 functions as a touch panel for receiving an operation of the user. The user can set operations and functions of the image processing apparatus 100 by carrying out an input operation from the operation display section 110.

The controller panel 120 which has a plurality of buttons receives the operation of the user. The controller panel 120 outputs a signal corresponding to an operation carried out by the user to a control section of the image processing apparatus 100. The controller panel 120 contains a button used to instruct the start of reading a document by the scanner.

The printer section 130 forms an image on a sheet according to image information generated by the image reading section 200 or image information received via a communication path. The printer section 130 forms an image through, for example, the following processing. An image forming section of the printer section 130 forms an electrostatic latent image on a photoconductive drum according to the image information. The image forming section of the printer section 130 adheres a developing agent on the electrostatic latent image to form a visible image. A toner is exemplified as the developing agent. A transfer section of the printer section 130 transfers the visible image onto the sheet. A fixing section of the printer section 130 heats and pressurizes the sheet to fix the visible image on the sheet. The sheet on which an image is formed may be a sheet accommodated in the sheet accommodation section 140 or a manually fed sheet.

The sheet accommodation section 140 accommodates the sheet used for the image forming processing carried out by the printer section 130.

The image reading section 200 reads the image information serving as a read object as brightness and darkness of light. The image reading section 200 records the read image information. The recorded image information may be sent to other image processing apparatus via a network. The recorded image information may be used to form an image on the sheet by the printer section 130.

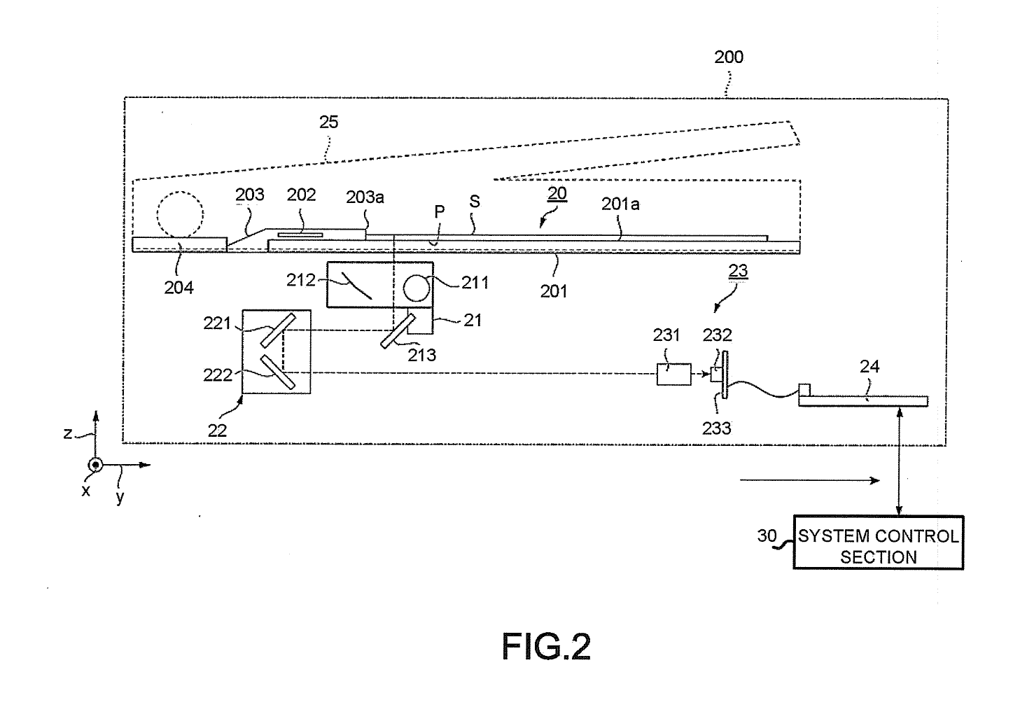

FIG. 2 is a schematic diagram exemplifying the structure of the image reading section 200.

The image reading section 200 is provided with a document table 20, a first carriage 21, a second carriage 22, an image capturing section 23, a control section 24 and an ADF (Automatic Document Feeder) 25. A direction in which the first carriage 21 moves refers to a sub-scanning direction y. In the document table 20, a direction orthogonal to the sub-scanning direction y refers to a main scanning direction x. A direction orthogonal to the main scanning direction x and the sub-scanning direction y refers to a height direction z.

The document table 20 comprises a document table glass 201, a shading plate 202, a document scale 203 and a through-read glass 204.

The document table glass 201 includes a placing surface 201a on which a sheet S is placed. The shading plate 202 is constituted by a white member. The shading plate 202 has white which is a reference when a shading correction is carried out to the image (hereinafter, referred to as a “read image”) read from the sheet S. The shading plate 202 is a long shape in the main scanning direction x. The document scale 203 shows a position of the sheet S placed on the document table glass 201. A tip reference section 203a is arranged at the end portion of the document scale 203. The tip reference section 203a forms difference in level with the placing surface 201a of the document table glass 201 to form a convex portion for pressing against the end portion of the sheet S. The sheet S is pressed against the tip reference section 203a on the document table glass 201 and thus the position of the sheet S is determined. A position at which corners of tips of the sheet S is placed is predetermined on the placing surface 201a. Positions of the main scanning direction x and the sub-scanning direction y are determined by placing the corners of the tips of the sheet S at the predetermined position.

The first carriage 21 is equipped with a light source 211, a reflector 212 and a first mirror 213. The light source 211 emits light. The reflector 212 reflects the light emitted from the light source 211. The light reflected by the reflector 212 is emitted to the shading plate 202 and the sheet S uniformly. Light distribution characteristics of the main scanning direction x at the read position of the sheet S are adjusted according to the reflected light of the emitted light. The first mirror 213 reflects the light reflected by the shading plate 202 and the sheet S towards a second mirror 221 of the second carriage 22.

The second carriage 22 is equipped with the second mirror 221 and a third mirror 222. The second mirror 221 reflects the light reflected by the first mirror 213 towards the third mirror 222. The third mirror 222 reflects the light reflected by the second mirror 221 to a condenser lens 231 of the image capturing section 23.

The image capturing section 23 is equipped with the condenser lens 231, a CCD sensor 232 and a CCD substrate 233. The condenser lens 231 condenses the light reflected by the third mirror 222. The condenser lens 231 makes the condensed light to be imaged on an imaging plane (reading plane) of the CCD sensor 232. The CCD sensor 232 is installed on the CCD substrate 233. For example, the CCD sensor 232 is a hybrid 4-line sensor. The hybrid 4-line sensor contains a 3-line sensor for reading a color image and a 1-line sensor for reading a monochrome image. The 3-line sensor reads R (red) light, G (green) light and B (blue) light. The CCD sensor 232 converts the light imaged by the condenser lens 231 into an electric charge. Through the conversion process, the CCD sensor 232 converts an image formed by the condenser lens 231 into an electrical signal. The CCD substrate 233 generates image data according to the electrical signal generated by a photoelectric conversion of the CCD sensor 232. When the image data is generated, the CCD substrate 233 generates image data with the use of correction information obtained by a shading correction processing in advance. The CCD substrate 233 outputs the generated image data to the control section 24. The foregoing processing carried out by the CCD substrate 233 is executed by an AFE (Analog Front End) installed on the CCD substrate 233.

The control section 24 controls the first carriage 21, the second carriage 22 and the image capturing section 23. For example, the control section 24 controls the movement of the first carriage 21 and the lighting/extinction of the light source 211 of the first carriage 21.For example, the control section 24 controls the operations of the image capturing section 23.

The control section 24 controls the state of the image processing apparatus 100 to be either of a normal state and a low-power state. The normal state is a state capable of reading an image of a document in response to the instruction of the user. In the normal state, a timing generator installed on the CCD substrate 233 outputs a CCD control signal to the CCD sensor 232. The low-power state is a state incapable of reading the image of the document in response to the instruction, in which power consumption is lower than that in the normal state. In the low-power state, the timing generator installed on the CCD substrate 233 stops. Thus, in the low-power state, the CCD control signal cannot be output and the operation of the CCD sensor 232 stops.

The first carriage 21 moves in sub-scanning direction y under the control of the control section 24. The second carriage 22 moves at a half speed in the same direction as the first carriage 21 along with the movement of the first carriage 21. Through such a movement, even if the first carriage 21 moves, an optical path length of the light reaching the imaging plane of the CCD sensor 232 does not vary. That is, the optical path length of the light in an optical system composed of the first mirror 213, the second mirror 221, the third mirror 222 and the condenser lens 231 is constant. In other words, the optical path length from the placing surface 201a to the imaging plane of the CCD sensor 232 is constant

For example, as exemplified in FIG. 2, the first carriage 21 moves from left to right along the sub-scanning direction y. As the first carriage 21 moves along the sub-scanning direction y, a reading position P of the sheet S moves as well. Thus, the reading position P moves from left to right along the sub-scanning direction y. The reading position P is a position corresponding to one line of the main scanning direction x. Through the movement of the reading position P in the sub-scanning direction y, images of the different reading positions P of the sheet S are sequentially formed on the imaging plane of the CCD sensor 232. The CCD sensor 232 outputs a signal corresponding to the formed image of the reading position P as a signal corresponding to one line of the main scanning direction x. The CCD substrate 233 generates image data of the whole sheet S on the basis of signals corresponding to a plurality of lines.

The ADF 25 is equipped with a document tray, a conveyance mechanism for conveying the document and a sheet discharge tray that are not shown in FIG. 2. The document to be read is placed on the document tray. The conveyance mechanism conveys the document placed on the document tray towards the through-read glass 204. The conveyance mechanism discharges the read document conveyed from the through-read glass 204 towards the sheet discharge tray.

The image processing apparatus 100 is provided with a system control section 30 for processing the image data read by the image reading section 200. The system control section 30 receives the image data (the first image data) from the control section 24 in the image reading section 200. The system control section 30 carries out an image processing corresponding to a setting of the user for the received image data.

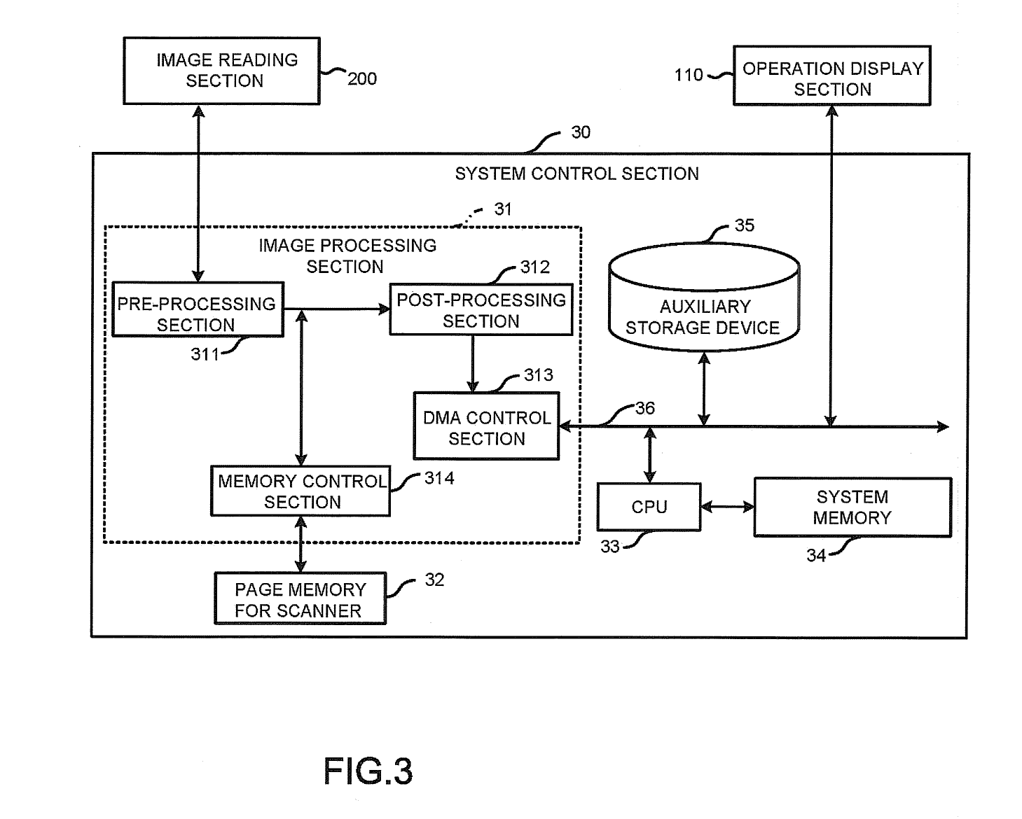

FIG. 3 is a schematic diagram exemplifying the structure of the system control section 30. The system control section 30 is equipped with an image processing section 31, a page memory for scanner 32, a CPU (Central Processing Unit) 33, a system memory 34, an auxiliary storage device 35 and a system bus 36. The image processing section 31 comprises a pre-processing section 311, a post-processing section 312, DMA (Direct Memory Access) control section 313 and a memory control section 314. The image processing section 31 is constituted by hardware for reducing the load of the CPU 33. The image processing section 31, for example, is constituted by hardware such as an ASIC (Application Specific Integrated Circuit).

The pre-processing section 311 carries out the image processing for the image data received from the image reading section 200. The pre-processing section 311, for example, carries out the image processing (pre-processing) containing an image processing which is not changed according to the setting of the user for the image data. The pre-processing is, for example, a defect correction processing of a pixel defect, a processing for removing images such as rubbish adhered to the document or the document table glass 201 and the like.

The post-processing section 312 carries out the image processing (post-processing) containing an image processing corresponding to the setting of the user for the image data (the second image data) processed by the pre-processing section 311. The post-processing contains any one of, for example, a trimming processing, a reduction processing, an enlargement processing, a color conversion processing, a resolution degree conversion processing and an image synthesis processing. The post-processing section 312 further carries out an irreversible image processing such as a conversion processing into a JPEG format, in addition to the image processing corresponding to the setting of the user.

The DMA control section 313 transfers the image data (the third image data) processed by the post-processing section 312 to the system memory 34 via the system bus 36. The memory control section 314 records the image data processed by the pre-processing section 311 in the page memory for scanner 32. The memory control section 314 reads out the image data, processed by the pre-processing section 311, which is recorded in the page memory for scanner 32 and outputs the read image data to the post-processing section 312.

The page memory for scanner 32 has a capacity of storing two pages of A3-size full-color documents. The page memory for scanner 32 is constituted by, for example, a DRAM (Dynamic Random Access Memory).

The CPU 33 controls the whole of the system control section 30. The CPU 33 reads out the image data recorded in the system memory 34 and displays the read image data on the operation display section 110 for the preview. The CPU 33 receives an instruction signal for instructing whether the setting is changed or not from the operation display section 110 to determine whether the setting is changed or not. If it is determined that the setting is changed, the CPU 33 changes the setting of the image processing of the post-processing of the image processing section 31 according to the instruction signal of the change of the setting.

The CPU 33 reads out the image data, processed by the pre-processing section 311, which is recorded in the page memory for scanner 32 and controls the post-processing section 312 of the image processing section 31 to carry out a processing on the read image data corresponding to the change of the setting according to the instruction signal of the change of the setting from the operation display section 110. If it is determined that the setting is not changed, the CPU 33 reads out the image data recorded in the system memory 34, files the read image data and then stores the filed image data in the auxiliary storage device 35.

The system memory 34 is a memory serving as a main storage device capable of directly being accessed by the CPU 33. The auxiliary storage device 35 is a storage connected with the system bus 36.

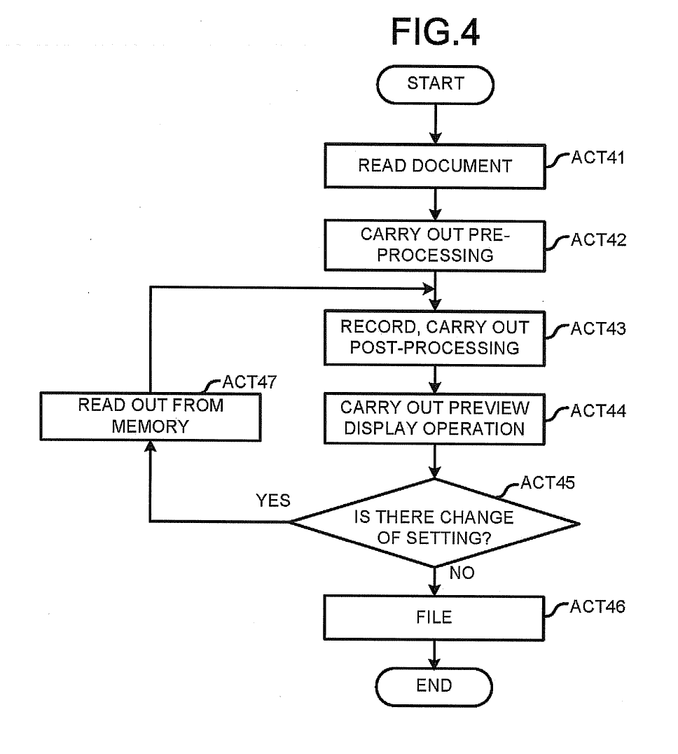

FIG. 4 is a schematic diagram exemplifying a scanning operation of the image processing apparatus 100.

The user places a document on the document tray of the ADF 25 to carry out a setting operation relating to a scanning operation through the operation display section 110. Next, the user presses a button in the controller panel 120 to instruct the start of reading the document after the setting operation. In this way, the ADF 25 starts the conveyance of the document, and the image reading section 200 reads the document conveyed by the ADF 25 (ACT 41). The pre-processing section 311 carries out an image processing serving as the pre-processing for the image data (ACT 42). The memory control section 314 records the image data processed by the pre-processing section 311 in the page memory for scanner 32. The post-processing section 312 carries out an image processing serving as the post-processing for the image data processed by the pre-processing section 311 (ACT 43).

The DMA control section 313 transfers the image data processed by the post-processing section 312 to the system memory 34 via the system bus 36. The CPU 33 reads out the image data recorded in the system memory 34 and displays the read image data on the operation display section 110 for the preview (ACT 44). A button used by the user to instruct whether or not the change of the setting is carried out is displayed on the screen of the preview display. The user who confirms the image data through the preview display can select the button for instructing whether or not the change of the setting is carried out.

The CPU 33 receives the instruction signal for instructing whether the setting is changed or not from the operation display section 110 to determine whether the setting is changed or not (ACT 45). In a case in which the setting is changed (YES in ACT 45), the CPU 33 controls the image processing section 31 to read out the image data, processed by the pre-processing section 311, which is recorded in the page memory for scanner (ACT 47). The CPU 33 changes the setting of the image processing of the post-processing by the image processing section 31 in response to the instruction signal of the change of the setting. The CPU 33 returns to the processing in ACT 43 after the processing in ACT 47; however, if the image data processed by the pre-processing section 311 is already stored, the processing of recording the image data processed by the pre-processing section 311 in the page memory for scanner 32 may be omitted.

If it is determined that the setting is not changed (NO in ACT 45), the CPU 33 reads out the image data recorded in the system memory 34, files the read image data and then stores the filed image data in the auxiliary storage device 35 (ACT 46).

In the above-mentioned embodiment, the processing carried out by the memory control section 314 and the page memory for scanner 32 which is not limited to be arranged after the processing carried out by the pre-processing section 311 may be arranged before the processing carried out by the pre-processing section-311.

In a case in which the document size cannot be identified at the time the document size is read by the image reading section 200, the page memory for scanner 32 may acquire a standard size larger than the document size. In this case, even after the document is read, the document can be trimmed and filed according to an optical document size through an operation of the user.

According to at least one embodiment described above, through storing the image data processed by the pre-processing section 311 in the page memory for scanner 32, a different image processing can be carried out for the image data of the document through the hardware without reading the document that is once read again. After the user confirms an image of the image data obtained after the document is read through the preview display, the setting of the image processing carried out through the hardware can be changed. In this way, an image processing can be carried out for the image data through the hardware according to the changed setting without reading the document again.

For example, in a case of carrying out an image processing according to a different setting after the confirmation of the image through the preview display, it may also be considered to carry out the image processing corresponding to the different setting for the image data to which the image processing is carried out through the hardware once. However, in such a structure, in the hardware processing, in a case in which the irreversible processing such as a JPEG is contained, there is a problem that deterioration of image quality is further worse each time the image processing is carried out. However, in the foregoing embodiment, the image data to which no post-processing containing the irreversible processing is carried out is stored in the page memory for scanner 32, which does not cause the above-mentioned problem.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. An image processing apparatus, comprising:
a scanner section configured to read a document to output first image data;
a pre-processing section configured to carry out a pre-processing as an image processing for the first image data output by the scanner section to output second image data, wherein the pre-processing being not changeable by setting of a user;
a memory that stores the second image data output by the pre-processing section;
a post-processing section configured to read the second image data out of the memory, the post-processing section being configured to carry out a post-processing for the second image data to output third image data, wherein the post-processing being changeable by the setting of a user; and
a processor configured to determine whether the setting was changed by a user after the post-processing section had output the third image data, the processor being configured to control the post-processing section to read the second image data out of the memory if the processor determined that there is the change of the setting, the processor being configured to change setting of the post-processing section, the processor being configured to control the post-processing section to carry out the post-processing corresponding to the changed setting for the second image data read from the memory to output the third image data.

2. The image processing apparatus according to claim 1, further comprising:
a display section configured to display the third image data output by the post-processing section; and
an input section configured to receive an input of change of the setting from the user, wherein the user inputs the change of the setting from the input section on the basis of the third image data displayed on the display section.

3. The image processing apparatus according to claim 1, wherein the pre-processing section and the post-processing section are constituted by hardware.

4. The image processing apparatus according to claim 1, further comprising:
a memory control section configured to control the memory to store and read out the second image data.

5. The image processing apparatus according to claim 1, wherein the post-processing further contains an irreversible image processing.

6. The image processing apparatus according to claim 1, wherein the pre-processing at least contains a correction processing of a pixel defect.

7. The image processing apparatus according to claim 1, wherein the post-processing contains any one of a trimming processing, a reduction processing, an enlargement processing, a color conversion processing, a resolution degree conversion processing and an image synthesis processing.

8. The image processing apparatus according to claim 1, wherein the setting relates to a trimming processing, a reduction processing, an enlargement processing, a color conversion processing, a resolution degree conversion processing and an image synthesis processing.

9. The image processing apparatus according to claim 1, further comprising:
a file section configured to file the third image data.

10. The image processing apparatus according to claim 9, wherein the file section files the third image data in a case in which the setting is not changed.

11. An image processing method comprising:
reading, by a pre-processing section of an image processing apparatus, a document to output first image data;
carrying out, by the pre-processing section, a pre-processing as an image processing for the output first image data to output second image data, wherein the pre-processing being not changeable by setting of a user;
storing the output second image data in a memory;
reading, by a post-processing section of the image processing apparatus, the second image data out of the memory,
carrying out, by the post-processing section, a post-processing for the second image data to output third image data, wherein the post-processing being changeable by the setting of a user;
determining whether the setting was changed by a user after the third image data had been output; and
if it is determined that there is the change of the setting,
reading, by the post-processing section, the second image data out of the memory,
changing setting of the post-processing section, and
carrying out, by the post-processing section, the post-processing corresponding to the changed setting for the second image data read from the memory to output the third image data.

12. The method according to claim 11, further comprising:
displaying the output third image data on a display section; and
receiving an input of change of the setting by the user on the basis of the third image data displayed on the display section.

13. The method for the image processing apparatus according to claim 11, wherein the pre-processing section and the post-processing section are constituted by hardware.

14. The method for the image processing apparatus according to claim 11, further comprising:
controlling the memory to store and read out the second image data.

15. The method for the image processing apparatus according to claim 11, wherein the post-processing further includes an irreversible image processing.

16. The method for the image processing apparatus according to claim 11, wherein the pre-processing includes at least a correction processing of a pixel defect.

17. The method for the image processing apparatus according to claim 11, wherein the post-processing includes any one of a trimming processing, a reduction processing, an enlargement processing, a color conversion processing, a resolution degree conversion processing and an image synthesis processing.

18. The method for the image processing apparatus according to claim 11, wherein the setting relates to the trimming processing, a reduction processing, an enlargement processing, a color conversion processing, a resolution degree conversion processing and an image synthesis processing.

19. The method for the image processing apparatus according to claim 11, further comprising:
filing the third image data.

20. The method for the image processing apparatus according to claim 19, wherein the filing includes filing the third image data in a case in which the setting is not changed.
